(19) United States
(12) Patent Application Publication
(10) Pub. No.: US 2017/0208165 A1
(43) Pub. Date: Jul. 20, 2017

(54) Information Input Processing Method and Mobile Terminal

(71) Applicant: Huawei Technologies Co., Ltd., Shenzhen (CN)

(72) Inventors: Wenbin Gu, Shenzhen (CN); Zhaohui Wu, Tokyo (JP)

(21) Appl. No.: 15/329,432

(22) PCT Filed: Jul. 31, 2014
(86) PCT No.: PCT/CN2014/083417

§ 371 Date: Jan. 26, 2017

(51) Int. Cl. H04M 1/725; G06F 3/023; G06F 3/041

(52) U.S. Cl. CPC H04M 1/72519; G06F 3/0418; G06F 3/0233; G06F 2203/04105; H04M 2250/12

(57) ABSTRACT

An information input processing method and a mobile terminal. The processing method includes correcting, by the mobile terminal according to shake shift information of the mobile terminal generated because of the shake, the first position to a second position when a user performs an input operation at a first position in an input area of a mobile terminal, when the mobile terminal determines that the mobile terminal undergoes a shake, and determining, by the mobile terminal according to the second position, required information that the user wants to input.

### CROSS REFERENCE TO RELATED APPLICATIONS

This application is a U.S. national stage of international patent application No. PCT/CN2014/083417 filed on Jul. 31, 2014, which is hereby incorporated by reference in its entirety.

### TECHNICAL FIELD

Embodiments of the present disclosure relate to the field of communications technologies, and in particular, to an information input processing method and a mobile terminal.

### BACKGROUND

With continuous advancement of mobile terminal technologies, a user uses a mobile terminal in more scenarios. Generally, a smart phone is used as an example, the user may also use various applications in the smart phone to perform interactive communication when using a vehicle such as a car or a subway. A user with a smart phone in hand, shakes when a vehicle starts or is braked, and the smart phone is also shaken. Therefore when the user uses the smart phone to perform an input operation, when error information is input or information input fails occurs because of interference from a shake generated on the smart phone. For example, if information that the user expects to input is a character a, the user taps a key a on an input keyboard (a physical keyboard in the smart phone or a virtual keyboard displayed on a touchscreen) in order to perform the input operation. However, when the user taps the key a, if the smart phone is shaken, the user actually taps a key s, that is, a character actually input by the user under the interference from the shake is an s instead of the character a that the user expects to input. Alternatively, the user taps a blank position between the key a and the key s under the interference from the shake, and as a result the information input fails. It can be learned that when the mobile terminal undergoes a shake because of an objective reason, input efficiency of the user is affected, and especially in a very bumpy environment, and to successfully input required information, the user needs to have an excellent skill and be very patient, thereby bringing inconvenience to the user.

### SUMMARY

Embodiments of the present disclosure provide an information input processing method and a mobile terminal in order to improve information input efficiency.

According to a first aspect, an embodiment of the present disclosure provides an information input processing method, where the processing method includes correcting, by the mobile terminal according to shake shift information of the mobile terminal that is generated because of a shake, the first position to a second position when a user performs an input operation at a first position in an input area of a mobile terminal, if the mobile terminal determines that the mobile terminal undergoes the shake, and determining, by the mobile terminal according to the second position, required information that the user wants to input.

With reference to the first aspect, in a first implementation manner, determining, by the mobile terminal according to the second position, information that the user wants to input includes determining information corresponding to the second position as the required information if the second position is a valid information input position in the input area, or determining, in all valid information input positions in the input area, information corresponding to a valid information input position closest to the second position as the required information if the second position is not any one of valid information input positions in the input area.

With reference to the first implementation manner of the first aspect, in a second implementation manner, the processing method further includes determining, by the mobile terminal according to position information reported by a shake detector at two adjacent sampling time points, position change information of the mobile terminal, where the position change information includes a position change direction and a moving distance in the position change direction, and the mobile terminal determining that the mobile terminal undergoes a shake includes determining that the mobile terminal undergoes a shake, and determining the shake shift information according to the position change information when the mobile terminal determines that the position change information of the mobile terminal meets an input position correction condition.

With reference to the second implementation manner of the first aspect, in a third implementation manner, determining the shake shift information according to the position change information includes determining, in the position change information, a first position change direction parallel to a plane on which the input area is located, and determining the shake shift information according to the first position change direction and a moving distance in the first position change direction.

With reference to the third implementation manner of the first aspect, in a fourth implementation manner, correcting, by the mobile terminal according to shake shift information of the mobile terminal that is generated because of the shake, the first position to a second position includes determining coordinates of the second position in the input area according to coordinates of the first position in the input area and the shake shift information.

With reference to any one of the implementation manners from the first aspect to the fourth implementation manner of the first aspect, in a fifth implementation manner, the processing method further includes controlling, by the mobile terminal according to multiple pieces of position information that are continuously reported by the shake detector, a time interval between the two adjacent sampling time points.

According to a second aspect, an embodiment of the present disclosure provides a mobile terminal, including a correction module configured to correct the first position to a second position according to shake shift information of the mobile terminal generated because of the shake when a user performs an input operation at a first position in an input area of the mobile terminal, if the mobile terminal undergoes a shake, and a determining module configured to determine, according to the second position, required information that the user wants to input.

With reference to the second aspect, in a first implementation manner, the determining module is further configured to determine information corresponding to the second position as the required information if the second position is a valid information input position in the input area, or determine, in all valid information input positions in the input area, information corresponding to a valid information input position closest to the second position as the required information if the second position is not any one of valid information input positions in the input area.

With reference to the first implementation manner of the second aspect, in a second implementation manner, the mobile terminal further includes a shake detector, where the correction module is further configured to determine position change information of the mobile terminal according to position information that is reported by the shake detector at two adjacent sampling time points, where the position change information includes a position change direction and a moving distance in the position change direction, and when the correction module determines that the position change information of the mobile terminal meets an input position correction condition, it is determined that the mobile terminal undergoes a shake, and the shake shift information is determined according to the position change information.

With reference to the second implementation manner of the second aspect, in a third implementation manner, the correction module is further configured to determine, in the position change information, a first position change direction parallel to a plane on which the input area is located, and determine the shake shift information according to the first position change direction and a moving distance in the first position change direction.

With reference to the third implementation manner of the second aspect, in a fourth implementation manner, the correction module is further configured to determine coordinates of the second position in the input area according to coordinates of the first position in the input area and the shake shift information.

With reference to any one of the implementation manners from the second aspect to the fourth implementation manner of the second aspect, in a fifth implementation manner, the correction module is further configured to control a time interval between the two adjacent sampling time points according to multiple pieces of position information that are continuously reported by the shake detector.

According to a third aspect, an embodiment of the present disclosure provides a mobile terminal, including a processor configured to correct the first position to a second position according to shake shift information of the mobile terminal that is generated because of the shake when a user performs an input operation at a first position in an input area of the mobile terminal, if the mobile terminal undergoes a shake, and determine, according to the second position, required information that the user wants to input.

With reference to the third aspect, in a first implementation manner, the processor is further configured to determine information corresponding to the second position as the required information if the second position is a valid information input position in the input area, or determine, in all valid information input positions in the input area, information corresponding to a valid information input position closest to the second position as the required information if the second position is not any one of valid information input positions in the input area.

With reference to the first implementation manner of the third aspect, in a second implementation manner, the mobile terminal further includes a shake detector, where the processor is further configured to determine position change information of the mobile terminal according to position information that is reported by the shake detector at two adjacent sampling time points, where the position change information includes a position change direction and a moving distance in the position change direction, and when the processor determines that the position change information of the mobile terminal meets an input position correction condition, it is determined that the mobile terminal undergoes a shake, and the shake shift information is determined according to the position change information.

With reference to the second implementation manner of the third aspect, in a third implementation manner, the processor is further configured to determine, in the position change information, a first position change direction that is parallel to a plane on which the input area is located, and determine the shake shift information according to the first position change direction and a moving distance in the first position change direction.

With reference to the third implementation manner of the third aspect, in a fourth implementation manner, the processor is further configured to determine coordinates of the second position in the input area according to coordinates of the first position in the input area and the shake shift information.

With reference to any one of the implementation manners from the third aspect to the fourth implementation manner of the third aspect, in a fifth implementation manner, the processor is further configured to control a time interval between the two adjacent sampling time points according to multiple pieces of position information that are continuously reported by the shake detector.

According to the information input processing method and the mobile terminal that are provided in the embodiments of the present disclosure, when a user performs an input operation at a first position, if the mobile terminal determines that the mobile terminal undergoes a shake, the mobile terminal corrects the first position to a second position, and then the mobile terminal determines, according to the second position, required information that the user wants to input. Therefore, interference that a mobile phone shake brings to the input operation of the user may be avoided, input efficiency is improved, and satisfaction of user experience is enhanced.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show some embodiments of the present disclosure, and a person of ordinary skill in the art may still derive other drawings from these accompanying drawings without creative efforts.

FIG. 1 is a flowchart of Embodiment 1 of an information input processing method according to the present disclosure;

FIG. 2 is a flowchart of Embodiment 2 of an information input processing method according to the present disclosure;

FIG. 3 is a flowchart of Embodiment 3 of an information input processing method according to the present disclosure;

FIG. 4 is a structural diagram of Embodiment 1 of a mobile terminal according to the present disclosure;

FIG. 5 is a structural diagram of Embodiment 2 of a mobile terminal according to the present disclosure;

FIG. 6 is a structural diagram of Embodiment 3 of a mobile terminal according to the present disclosure;

FIG. 7 is a structural diagram of Embodiment 4 of a mobile terminal according to the present disclosure; and

FIG. 8 is a structural diagram of Embodiment 5 of a mobile terminal according to the present disclosure.

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

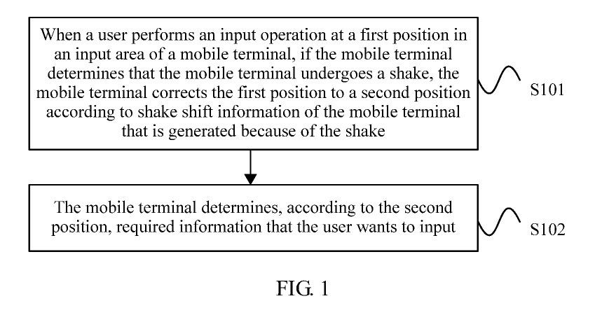

FIG. 1 is a flowchart of Embodiment 1 of an information input processing method according to the present disclosure. As shown in FIG. 1, this embodiment is executed by a mobile terminal. The mobile terminal, such as a common mobile phone or an iPad, may receive information that is input by a user. The specific processing method is as follows.

Step S101: When the user performs an input operation at a first position in an input area of the mobile terminal, if the mobile terminal determines that the mobile terminal undergoes a shake, the mobile terminal corrects the first position to a second position according to shake shift information of the mobile terminal that is generated because of the shake.

A common smart phone is used as an example. An input area of the mobile phone is an area in which a touchscreen of the mobile phone is located. When the mobile phone senses, using a built-in device such as a pressure sensor or a photo sensor, a tap action performed by the user on the touchscreen, it is determined that the user performs an input operation, and a first position is a position which the user taps at a current time point. It may be understood that on a mobile terminal with an input keyboard, an area in which the input keyboard is located is also the input area.

Because a shake detector built into the mobile terminal is always in a running state, the shake detector can detect in real time whether the mobile terminal undergoes a shake. When the mobile terminal undergoes a shake, a position of the mobile terminal inevitably changes, and shake shift information is generated. The foregoing shake detector may further be a tri-axis gyroscope, another sensor, or the like, and may obtain position information of the mobile phone in real time. That is, when sensing that the user performs an input operation, the mobile terminal can determine, using the shake detector, whether the mobile terminal undergoes a shake. For a working process of the foregoing shake detector, refer to a shake detection technology in the other approaches. For example, the shake detector can continuously report the detected position information of the mobile terminal at a preset time interval, and generally the preset time interval is relatively short (for example, 10 milliseconds (ms)). When sensing that the user performs an input operation, the mobile terminal can determine, according to the position information of the mobile terminal, whether the mobile terminal undergoes a shake in the process in which the user performs an input operation.

If the mobile terminal does not undergo a shake when the user performs an input operation, it indicates that the input operation performed by the user at the first position is expected by the user, and information such as a character, a web page link identifier, or a displayed option button that is at the first position is required information that the user expects to input.

If the mobile terminal undergoes a shake when the user performs an input operation, it indicates that a change that occurs in the position information of the mobile terminal interferes with the input operation of the user, that is, the input operation performed by the user at the first position is not expected by the user. For example, the user expects to input a character a, and when the user taps a position at which the character a is located, the mobile terminal is shifted to the left by an L distance because the mobile terminal undergoes a shake, and a position which the user actually taps is a position at which a character s is located, and in this case, the character a is the required information that the user expects to input, and the character s is not the required information that the user expects to input. Therefore, it is required to correct the first position at which the character s is located to a second position at which the character a is located according to shake shift information of the mobile terminal (that is the foregoing shift to the left by an L distance).

Step S102: The mobile terminal determines, according to the second position, required information that the user wants to input.

After correcting the first position to the second position, the mobile terminal determines, according to the second position, the required information that the user really wants to input, and then the mobile terminal can correctly execute an instruction of the user according to the required information. That is, in this embodiment, when learning that the user performs an input operation at the first position of the mobile terminal, the mobile terminal does not perform an execution according to information corresponding to the first position, but determines whether the input operation is interfered by a shake of the mobile terminal. The first position is corrected to improve efficiency of correct input of the user if the input operation is interfered with by the shake.

In this embodiment, when a user performs an input operation at a first position, if a mobile terminal determines that the mobile terminal undergoes a shake, the mobile terminal corrects the first position to a second position. Then, the mobile terminal determines, according to the second position, required information that the user wants to input. Therefore, interference that a mobile phone shake brings to the input operation of the user may be avoided, input efficiency is improved, and satisfaction of user experience is enhanced.

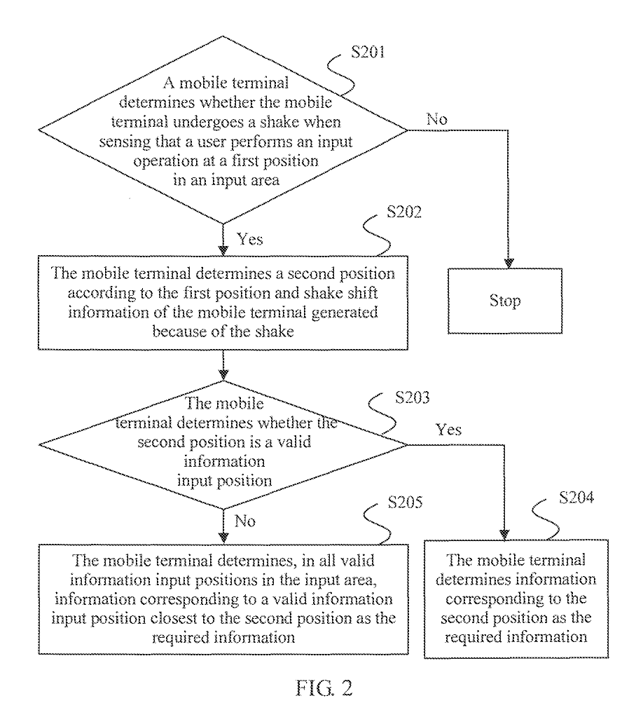

FIG. 2 is a flowchart of Embodiment 2 of an information input processing method according to the present disclosure. As shown in FIG. 2, this embodiment gives a further description based on Embodiment 1, and the method includes the following steps.

Step S201: A mobile terminal determines whether the mobile terminal undergoes a shake when sensing that a user performs an input operation at a first position in an input area. Step S202 is executed if the mobile terminal undergoes a shake, and no further step is executed if the mobile terminal does not shake.

For example, a shake detector built into a mobile terminal and in a working state can detect whether the mobile terminal undergoes a shake. For example, the shake detector includes a speed sensor, and determines that the mobile terminal undergoes a shake according to the detected change of a moving speed of the mobile terminal, and may further calculate shake shift information according to the change of the speed. Alternatively, the shake detector detects position information w1 of the mobile terminal at a time point t1, and then detects position information w2 at a time point (t1+10 ms). If there is a difference between the w1 and the w2, it indicates that the mobile terminal undergoes a shake, and the difference between the w1 and the w2 may reflect the shake shift information of the mobile terminal, that is, when the mobile terminal obtains shake shift information, it is determined that the mobile terminal undergoes a shake.

Step S202: The mobile terminal determines a second position according to the first position and shake shift information of the mobile terminal generated because of the shake.

The foregoing shake shift information is generated because of a shake, and a position of the mobile terminal inevitably changes such that shake shift information is generated when the mobile terminal undergoes a shake.

Further, when the mobile terminal undergoes a shake, the mobile terminal may obtain position change information of the mobile terminal, where the position change information includes a position change direction and a moving distance in the position change direction. If a face is used as a reference relative to the input area of the mobile terminal, the mobile terminal can move in various directions such as forward, backward, upward, downward, leftward, and rightward. The foregoing directions “forward and downward” are parallel to a direction that is perpendicular to a plane on which the input area is located. Therefore, moving distances in the directions “forward and backward” do not affect the input operation that is performed on the input area by the user, and moving distances in the forward and backward moving directions may not be considered, and only moving distances in directions of four dimensions leftward, rightward, forward, and backward and combinations thereof (upper left, lower left, upper right, and lower right) are processed. It can also be said that the mobile terminal determines, in the position change information, a first position change direction parallel to the plane on which the input area is located, and determines the shake shift information according to the first position change direction and a moving distance in the first position change direction.

For example, the mobile terminal generates a shift L because of a shake, but the shift L is generated because the mobile terminal is shifted in three directions, forward, upward, and leftward, that is, moving distances in the three directions forward, upward, and leftward can be calculated according to the shift L. Because a moving distance in the forward direction does not affect input of the user, the moving distance in the forward direction can be ignored, and only two directions upward and leftward and moving distances in the two directions upward and leftward are processed, where the two directions upward and leftward are two first position change directions, and the moving distances in the two directions upward and leftward are moving distances in the first position change directions.

A ShiftPara (l, r, f, b) parameter may be used to indicate the shake shift information, where an l, an r, an f, and a b respectively indicate moving distances in four directions, leftward, rightward, upward, and downward. To facilitate calculation by the mobile terminal, the l and the b are assigned negative values, and the r and the f are assigned positive values. For example, ShiftPara (−1, 0, 0, −1) indicates moving leftward by 1 and moving downward by 1, ShiftPara (0, 1, 1, 0) indicates moving rightward by 1 and moving upward by 1, and ShiftPara (−1, 1, 0, 0) indicates moving leftward by 1 and moving upward by 1.

Coordinates of the first position in the input area are represented using an OldPoint (X, Y), and coordinates NewPoint (X, Y) of the second position can be determined according to a formula OldPoint (X, Y)+ShiftPara (l, r, f, b). That is, in this embodiment, the coordinates of the second position in the input area can be determined according to the coordinates of the first position in the input area and the shake shift information.

For example, the user originally expects to perform a tap operation at a position at which coordinates (0, 0) in the input area are located, but because the mobile terminal undergoes a shake, and shake shift information ShiftPara (l, r, f, b) is ShiftPara (−1, 0, 0, −1), that is, the mobile terminal is shifted downward by 1 relative to the user, is shifted leftward by 1, and is not shifted in the upward direction or the leftward direction, that is, the first position which the user actually taps is (1, 1). Therefore, the second position NewPoint (0, 0) is obtained by calculating OldPoint (1, 1)+ShiftPara (−1, 0, 0, −1), and the position which the user expects to tap is determined.

Then the required information that the user wants to input is determined according to the second position which the user expects to tap. Preferably, considering factors such as an error in detected data, the determined second position is a not a valid information input position. It may be understood that the input area of the mobile terminal is relatively large, and in the input area, not all input operations of a position can be used to input information to the mobile terminal. For example, a web page is displayed on a touchscreen of a smart phone, and the touchscreen, which serves as the input area, displays two identifiers “next page” and “previous page” only at the top, and the remaining part displays only text information. Therefore, when the user taps a position at which the text information is located, no information is input to the mobile terminal, that is, the mobile terminal does not receive any information such as an operation instruction and a character. When the user taps the identifier “previous page,” that is, the user inputs an instruction “displaying a previous page” to the mobile terminal, the mobile terminal controls, according to the instruction “displaying a previous page,” the touchscreen to display content of a previous page. It may be understood that positions at which the foregoing two identifiers “next page” and “previous page” are located are the valid information input positions of the mobile terminal, that is, input of information can be implemented only when an input operation such as a tap operation is performed at the valid information input position. Therefore, considering that the second position may not be the valid information input position, optionally, step S203 further needs to be executed.

Step S203: The mobile terminal determines whether the second position is a valid information input position, and step S204 is executed if the second position is the valid information input position, or step S205 is executed if the second position is not the valid information input position.

It should be noted that in some cases, the valid information input position of the mobile terminal may change in real time. For example, if in content displayed at a current time point on the touchscreen of the smart phone, the identifiers “previous page” and “next page” are displayed at the top, the valid information input positions are positions at which the identifiers “previous page” and “next page” displayed on the touchscreen are located. However, at a next time point, content displayed on the touchscreen is a table of contents of various chapters that is displayed, in a form of five rows and two columns, in the middle part, that is, at this time the valid information input position is a position at which the table of contents of various chapters is displayed on the touchscreen, and the mobile terminal can learn all valid information input positions according to content that is currently displayed on the touchscreen.

Step S204: The mobile terminal determines information corresponding to the second position as the required information.

If the second position is the valid information input position in the input area, it is determined that information corresponding to the second position is the required information. For example if the second position is an exact position at which the identifier “previous page” is located, information corresponding to the second position, that is, the operation instruction “displaying a previous page,” is the required information.

Step S205: The mobile terminal determines, in all valid information input positions in the input area, information corresponding to a valid information input position closest to the second position as the required information.

At a current time point, the valid information input positions on the touchscreen of the mobile terminal are the positions at which the foregoing identifiers “previous page” and “next page” are located, but the second position determined by the mobile terminal in step S202 is not any one of the valid information input positions of the mobile terminal, for example, if the second position is between the identifier “previous page” and the identifier “next page,” the mobile terminal learns by respectively calculating, a distance between the second position and the identifier “previous page,” and a distance between the second position and the identifier “next page,” and determines by comparing, that the distance between the second position and the identifier “previous page” is longer than the distance between the second position and the identifier “next page,” thereby determining that the valid information input position closest to the second position is the position at which the identifier “previous page” is located, and in this case, the determined required information is the operation instruction “displaying a previous page,” and then the mobile terminal displays content of the previous page to the user according to the operation instruction “displaying a previous page.”

In this embodiment, when a user performs an input operation at a first position, the mobile terminal corrects the first position to a second position if a mobile terminal determines that the mobile terminal undergoes a shake, and then the mobile terminal determines, according to the second position, required information that the user wants to input. Therefore, interference that a mobile phone shake brings to the input operation of the user may be avoided, input efficiency is improved, and satisfaction of user experience is enhanced.

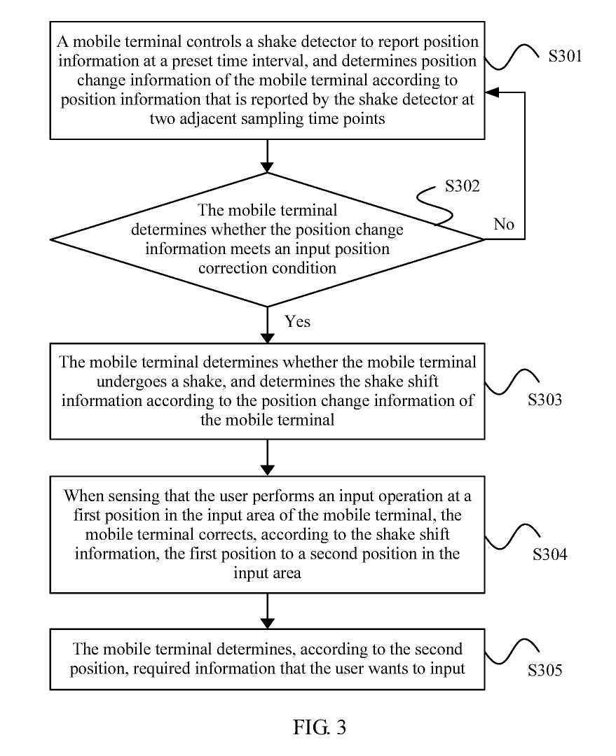

FIG. 3 is a flowchart of Embodiment 3 of an information input processing method according to the present disclosure. As shown in FIG. 3, there are various methods for a mobile terminal to determine whether the mobile terminal undergoes a shake. Based on the embodiment shown in the foregoing FIG. 1 or FIG. 2, in this embodiment, a method for detecting a shake is used as an example, which, however, shall not be construed as any limitation in a practical application. The method further includes the following steps.

Step S301: A mobile terminal controls a shake detector to report position information at a preset time interval, and determines position change information of the mobile terminal according to position information that is reported by the shake detector at two adjacent sampling time points.

The position change information includes a position change direction and a moving distance in the position change direction.

A running shake detector can detect real-time position information of the mobile terminal, and generally the mobile terminal can control the shake detector to detect, at a sampling time point, position information of the mobile terminal, and to perform reporting. A time interval between the two adjacent sampling time points is the foregoing preset time interval.

Optionally, the mobile terminal may further control the time interval between the two adjacent sampling time points according to multiple pieces of position information that are continuously reported by the shake detector. Position information reported at two sampling time points is used as an example. The shake detector reports position information 1 at a time point t1, and then reports position information 2 at a time point t2, and an interval between the time point t1 and the time point t2 is a preset time interval 15 ms. However, when the mobile terminal finds, by comparing the position information 1 with the position information 2, that position information of the mobile terminal significantly changes, it indicates that the mobile terminal is fiercely shaken at this time because of an external environment, and in order to obtain shake shift information accurately and in a timely manner, the mobile terminal may control the time interval between the two adjacent sampling time points of the shake detector and shorten the time interval to 10 ms. When the position information of the mobile terminal insignificantly changes, it indicates that the mobile terminal is not fiercely shaken at this time, and even if the user performs an input operation at this time, such a slight shake will not cause interference on the input operation of the user, and the time interval between the two adjacent sampling time points of the shake detector may be controlled and changed to be 20 ms. In this embodiment, an interval of a sampling time point of the shake detector is adjusted according to a shake level, which may ensure that a processing capability assigned by the mobile terminal to the shake detector is within a reasonable range, and may further ensure that performance of an operating system of the mobile terminal is in a balanced state, thereby facilitating a normal operation of the mobile terminal.

Step S302: The mobile terminal determines whether the position change information meets an input position correction condition, and step S303 is executed if the position change information meets the input position correction condition, or step S301 is executed if the position change information does not meet the input position correction condition.

An input position correction condition includes that the position change information affects the input operation of the user. For example, a plane on which the input area of the mobile terminal is located is used as a reference. When the position change information of the mobile terminal includes only a direction that is perpendicular to the plane on which the input area is located and a moving distance in the direction that is perpendicular to the plane on which the input area is located, in this case, the position change information will not cause interference on the input operation of the user, and the position change information of the mobile terminal does not meet the input position correction condition. Alternatively, when in addition to the direction that is perpendicular to the plane on which the input area is located and the moving distance in the direction that is perpendicular to the plane on which the input area is located, the position change information of the mobile terminal further includes a direction parallel to the plane on which the input area is located and a moving distance in the direction parallel to the plane on which the input area is located, it should be further determined whether the moving distance in the direction that is parallel to the plane on which the input area is located is within a preset range, where the preset range may be a value, or may be a value interval. A value interval [a1, a2] is used as an example. When a moving distance M (for example, the mobile terminal is shifted M millimeters (mm) to the lower right) is less than the a1, it indicates that the position information insignificantly changes, and even if the user performs an input operation, no interference will be caused on the input of the user. That is, the position change information does not meet the input position correction condition. When the M is greater than the a2, it indicates that the position information significantly changes, and possibly the mobile terminal is not shaken in this case. That is, the position change information does not meet the input position correction condition.

Step S303: The mobile terminal determines whether the mobile terminal undergoes a shake, and determines the shake shift information according to the position change information of the mobile terminal.

Further, in the position change information, a first position change direction parallel to the plane on which the input area is located is determined.

The shake shift information is determined according to the first position change direction and a moving distance in the first position change direction.

Step S304: When sensing that the user performs an input operation at a first position in the input area of the mobile terminal, the mobile terminal corrects, according to the shake shift information, the first position to a second position in the input area.

It may be understood that the foregoing step S303 simultaneously occurs with the learning, by the mobile terminal, that the user performs an input operation at the first position of the mobile terminal. Further, the foregoing steps S301 to S303 are continuously executed. Each time the mobile terminal obtains the shake shift information and at the same time the user performs no input operation, the mobile terminal discards the shake shift information and returns to step S301 to re-obtain new shake shift information. When the mobile terminal obtains the shake shift information at a time point and at the same time learns that the user performs an input operation, it indicates that the shake that generates the shake shift information has caused interference on the input operation of the user, and the first position is corrected to a second position according to the shake shift information. Even if there is a slight time difference between the foregoing step S303 and learning, by the mobile terminal, that the user performs an input operation at the first position of the mobile terminal, which is caused by a data processing delay of the mobile terminal, in practice, the shake that generates the shake shift information has caused interference on the input operation of the user.

Step S305: The mobile terminal determines, according to the second position, required information that the user wants to input.

For specific execution processes of the foregoing steps S304 and S305, reference may be made to the foregoing embodiment shown in FIG. 1 or FIG. 2, and details are not described herein again.

In this embodiment, the mobile terminal corrects the first position to a second position when a user performs an input operation at a first position, if a mobile terminal determines that the mobile terminal undergoes a shake, and then the mobile terminal determines, according to the second position, required information that the user wants to input. Therefore, interference that a mobile phone shake brings to the input operation of the user may be avoided, input efficiency is improved, and satisfaction of user experience is enhanced.

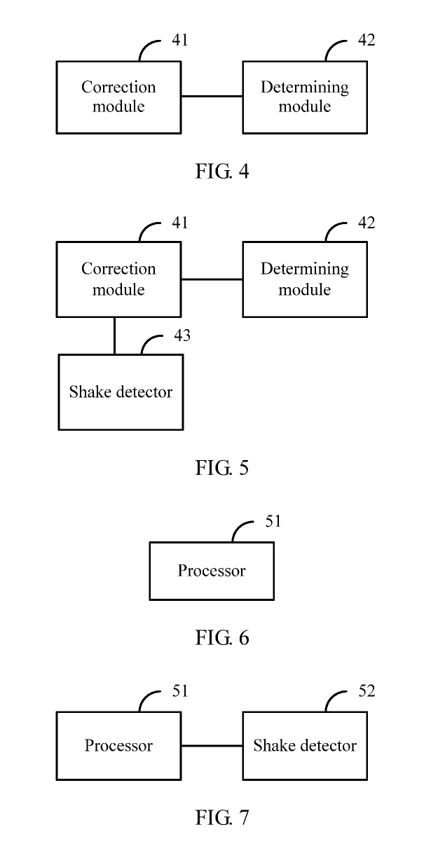

FIG. 4 is a structural diagram of Embodiment 1 of a mobile terminal according to the present disclosure. As shown in FIG. 4, this embodiment includes a correction module 41 configured to correct the first position to a second position according to shake shift information of the mobile terminal generated because of the shake when a user performs an input operation at a first position in an input area of the mobile terminal, if the mobile terminal undergoes a shake, and a determining module 42 configured to determine, according to the second position, required information that the user wants to input.

In this embodiment, the mobile terminal corrects the first position to a second position when a user performs an input operation at a first position, if a mobile terminal determines that the mobile terminal undergoes a shake, and then the mobile terminal determines, according to the second position, required information that the user wants to input. Therefore, interference that a mobile phone shake brings to the input operation of the user may be avoided, input efficiency is improved, and satisfaction of user experience is enhanced.

FIG. 5 is a structural diagram of Embodiment 2 of a mobile terminal according to the present disclosure. As shown in FIG. 5, this embodiment gives a further description based on the embodiment shown in FIG. 4. The determining module 42 is further configured to determine information corresponding to the second position as the required information if the second position is a valid information input position in the input area, or determine, in all valid information input positions in the input area, information corresponding to a valid information input position closest to the second position as the required information if the second position is not any one of valid information input positions of the mobile terminal.

The mobile terminal further includes a shake detector 43.

The correction module 41 is further configured to determine position change information of the mobile terminal according to position information reported by the shake detector 43 at two adjacent sampling time points, where the position change information includes a position change direction and a moving distance in the position change direction.

When the correction module 41 determines that the position change information of the mobile terminal meets an input position correction condition, it is determined that the mobile terminal undergoes a shake, and the shake shift information is determined according to the position change information.

The correction module 41 is further configured to determine, in the position change information, a first position change direction parallel to a plane on which the input area is located, and determine the shake shift information according to the first position change direction and a moving distance in the first position change direction.

The correction module 41 is further configured to determine coordinates of the second position in the input area according to coordinates of the first position in the input area and the shake shift information.

The correction module 41 is further configured to control a time interval between two adjacent sampling time points according to multiple pieces of position information that are continuously reported by the shake detector.

In this embodiment, when a user performs an input operation at a first position, if a mobile terminal determines that the mobile terminal undergoes a shake, the mobile terminal corrects the first position to a second position, and then the mobile terminal determines, according to the second position, required information that the user wants to input. Therefore, interference that a mobile phone shake brings to the input operation of the user may be avoided, input efficiency is improved, and satisfaction of user experience is enhanced.

It should be noted that in the embodiment shown in FIG. 4 or FIG. 5, various modules correspondingly execute various steps in any one of the embodiments shown in the foregoing FIG. 1 to FIG. 3. For a specific implementation process and a specific technical effect, reference may be made to any one of the embodiments shown in the foregoing FIG. 1 to FIG. 3.

FIG. 6 is a structural diagram of Embodiment 3 of a mobile terminal according to the present disclosure. As shown in FIG. 6, this embodiment includes a processor 51 configured to correct the first position to a second position according to shake shift information of the mobile terminal that is generated because of the shake when a user performs an input operation at a first position in an input area of the mobile terminal, if the mobile terminal undergoes a shake, and determine, according to the second position, required information that the user wants to input.

In this embodiment, the mobile terminal corrects the first position to a second position when a user performs an input operation at a first position, if a mobile terminal determines that the mobile terminal undergoes a shake, and then the mobile terminal determines, according to the second position, required information that the user wants to input. Therefore, interference that a mobile phone shake brings to the input operation of the user may be avoided, input efficiency is improved, and satisfaction of user experience is enhanced.

FIG. 7 is a structural diagram of Embodiment 4 of a mobile terminal according to the present disclosure. As shown in FIG. 7, this embodiment gives a further description based on the embodiment shown in FIG. 7. The processor 51 is further configured to determine information corresponding to the second position as the required information if the second position is a valid information input position in the input area, or determine, in all valid information input positions in the input area, information corresponding to a valid information input position closest to the second position as the required information if the second position is not any one of valid information input positions of the mobile terminal.

The mobile terminal further includes a shake detector 52.

The processor 51 is further configured to determine position change information of the mobile terminal according to position information that is reported by the shake detector 52 at two adjacent sampling time points, where the position change information includes a position change direction and a moving distance in the position change direction.

When the processor 51 determines that the position change information of the mobile terminal meets an input position correction condition, it is determined that the mobile terminal undergoes a shake, and the shake shift information is determined according to the position change information.

The processor 51 is further configured to determine, in the position change information, a first position change direction that is parallel to a plane on which the input area is located, and determine the shake shift information according to the first position change direction and a moving distance in the first position change direction.

The processor 51 is further configured to determine coordinates of the second position in the input area according to coordinates of the first position in the input area and the shake shift information.

The processor 51 is further configured to control a time interval between two adjacent sampling time points according to multiple pieces of position information that are continuously reported by the shake detector.

In this embodiment, when a user performs an input operation at a first position, if a mobile terminal determines that the mobile terminal undergoes a shake, the mobile terminal corrects the first position to a second position, and then the mobile terminal determines, according to the second position, required information that the user wants to input. Therefore, interference that a mobile phone shake brings to the input operation of the user may be avoided, input efficiency is improved, and satisfaction of user experience is enhanced.

It should be noted that all devices in the embodiment shown in FIG. 6 or FIG. 7, such as a processor and a shake detector, correspondingly execute all the steps in any one of the embodiments shown in the foregoing FIG. 1 to FIG. 3. For a specific implementation process and a specific technical effect, reference may be made to any one of the embodiments shown in the foregoing FIG. 1 to FIG. 3.

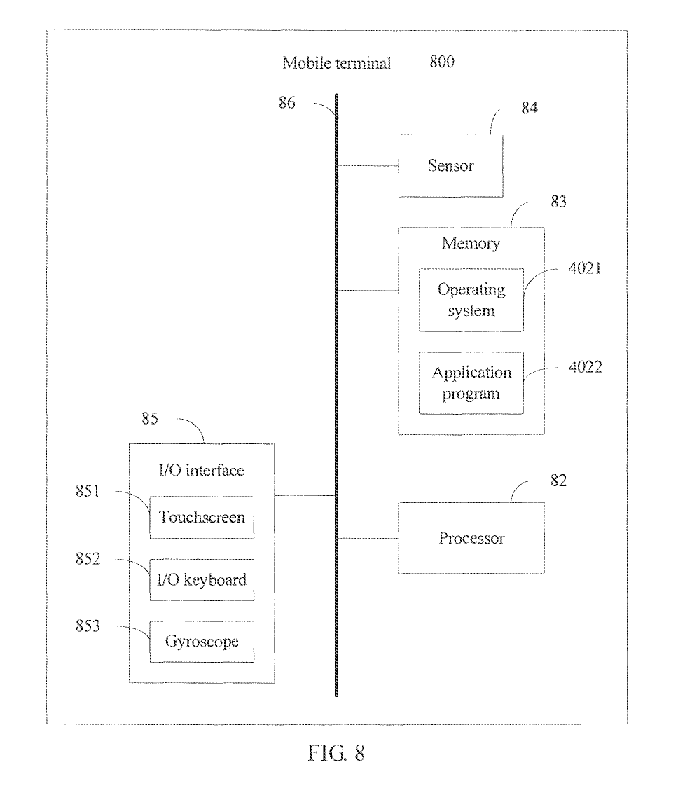

FIG. 8 is a structural diagram of Embodiment 5 of a mobile terminal according to the present disclosure. As shown in FIG. 8, the mobile terminal in this embodiment is merely exemplary, and it may be understood that the mobile terminal in a practical application may be a smart phone or an iPad. Modules and parts in different mobile terminal devices are different, therefore the mobile terminal in practice may have more or less parts than those shown in FIG. 8, and may combine two or more parts or may have different part configurations. Various parts shown in FIG. 8 may be implemented in hardware that includes one or more signal processing and/or application-specific integrated circuits, in software, or in a combination of hardware and software.

A mobile terminal 800 includes at least one processor 82, a memory 83, a sensor 84, an input/output (I/O) interface 85, and at least one communications bus 86. The communications bus 86 is configured to implement a connection and communication between various modules and components. The memory 83 may include a non-volatile solid-state memory and/or a dynamics non-volatile storage device, such as a flash memory and a rotatable disk drive. The sensor 84 includes multiple types of sensors, such as a speed sensor and a pressure sensor, and is configured to sense current position information of the mobile terminal, whether a shake occurs, whether a user performs an input operation, and the like.

Further, the I/O interface 85 includes a touchscreen 851 configured to display and input information, an I/O keyboard 852 (optionally) configured to input information, and a gyroscope 853, where the gyroscope 853 may be the foregoing tri-axis gyroscope, or the gyroscope coordinates with the foregoing sensor to implement a function of the shake detector in the foregoing embodiments.

Further, the processor 82 may control, using the communications bus 86, a touchscreen 851 to display a valid information input position to the user.

The memory 83 includes an operating system 4021 and an application program 4022, where the operating system 4021 includes various operating system programs and is configured to implement various operations that are based on hardware. The application program 4022 includes various application programs and is configured to implement various application functions, such as a position correction program, an input operation execution program, or a program for processing data that is obtained by the sensor, the gyroscope, or the like, where the program for processing the data includes a program for calculating a shift amount of the mobile terminal.

Further, the memory 83 may further store a preset time interval and a position correction condition. For example, the memory 83 may store the foregoing value interval [a1, a2].

The processor 82 communicates with the foregoing modules and components using the communications bus 86. Further, when the user performs an input operation at a first position on the touchscreen, devices such as the pressure sensor may sense that the user performs an input operation at the first position. Based on data obtained by the sensor 84, the gyroscope 853, or the like, according to the preset time interval stored in the memory 83 and the position correction condition stored in the memory 83, the processor 82 determines that the mobile terminal 800 undergoes a shake, and then corrects the first position to a second position according to the position correction program. Finally, according to the input operation execution program in the memory 83, the processor 82 displays required information corresponding to the second position, or performs a related execution according to the required information corresponding to the second position, such as controlling the touchscreen 851 to display information of a next page.

In this embodiment, when a user performs an input operation at a first position, if a mobile terminal determines that the mobile terminal undergoes a shake, the mobile terminal corrects the first position to a second position, and then the mobile terminal determines, according to the second position, required information that the user wants to input. Therefore, interference that a mobile phone shake brings to the input operation of the user may be avoided, input efficiency is improved, and satisfaction of user experience is enhanced.

A person of ordinary skill in the art may understand that all or some of the steps of the method embodiments may be implemented by a program instructing relevant hardware. The program may be stored in a computer readable storage medium. The steps of the method embodiments are performed when the program runs. The foregoing storage medium includes any medium that can store program code, such as a read-only memory (ROM), a random access memory (RAM), a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1. An information input processing method, comprising:
receiving, by a mobile terminal, an input operation performed by a user at a first position in an input area of the mobile terminal;
determining, by the mobile terminal, whether the mobile terminal undergoes a shake;
correcting, by the mobile terminal according to shake shift information of the mobile terminal generated because of the shake, the first position to a second position when the mobile terminal undergoes the shake; and
determining, by the mobile terminal according to the second position, required information that the user wants to input.

2. The processing method according to claim 1, wherein determining the required information that the user wants to input comprises:
determining information corresponding to the second position as the required information when the second position is a valid information input position in the input area; and
determining, in all valid information input positions in the input area, information corresponding to a valid information input position closest to the second position as the required information when the second position is not any one of valid information input positions in the input area.

3. The processing method according to claim 1, further comprising determining, by the mobile terminal according to position information reported by a shake detector at two adjacent sampling time points, position change information of the mobile terminal, wherein the position change information comprises a position change direction and a moving distance in the position change direction, and
wherein determining whether the mobile terminal undergoes the shake comprises:
determining that the mobile terminal undergoes the shake when the mobile terminal determines that the position change information of the mobile terminal meets an input position correction condition; and
determining the shake shift information according to the position change information.

4. The processing method according to claim 3, wherein determining the shake shift information comprises:
determining, in the position change information, a first position change direction in parallel to a plane on which the input area is located; and
determining the shake shift information according to the first position change direction and a moving distance in the first position change direction.

5. The processing method according to claim 1, wherein correcting the first position to the second position comprises calculating coordinates of the second position in the input area according to coordinates of the first position in the input area and the shake shift information.

6. The processing method according to claim 1, further comprising controlling, by the mobile terminal according to multiple pieces of position information that are continuously reported by a shake detector, a time interval between two adjacent sampling time points, wherein position information changing gets smaller when the time interval gets longer.

7.-12. (canceled)

13. A mobile terminal, comprising:
a processor; and
a non-transitory computer readable medium coupled to the processor and configured to store program codes which, when executed by the processor cause the processor to:
receive an input operation performed by a user at a first position in an input area of the mobile terminal;
determine whether the mobile terminal undergoes a shake;
correct the first position to a second position according to shake shift information of the mobile terminal generated because of the shake when the mobile terminal undergoes the shake; and
determine, according to the second position, required information that the user wants to input.

14. The mobile terminal according to claim 13, wherein when determining the required information, the processor is further caused to:
determine information corresponding to the second position as the required information when the second position is a valid information input position in the input area; and
determine, in all valid information input positions in the input area, information corresponding to a valid information input position closest to the second position as the required information when the second position is not any one of valid information input positions in the input area.

15. The mobile terminal according to claim 13, further comprising a shake detector coupled to the processor, wherein the processor is further caused to:
determine position change information of the mobile terminal according to position information reported by the shake detector at two adjacent sampling time points, wherein the position change information comprises a position change direction and a moving distance in the position change direction;
determine that the mobile terminal undergoes the shake when the position change information of the mobile terminal meets an input position correction condition; and
determine the shake shift information according to the position change information.

16. The mobile terminal according to claim 15, wherein when determining the shake shift information, the processor is further caused to:
determine, in the position change information, a first position change direction in parallel to a plane on which the input area is located; and
determine the shake shift information according to the first position change direction and a moving distance in the first position change direction.

17. The mobile terminal according to claim 13, wherein when correcting the first position to the second position, the processor is further caused to calculate coordinates of the second position in the input area according to coordinates of the first position in the input area and the shake shift information.

18. The mobile terminal according to claim 13, wherein the processor is further caused to control a time interval between two adjacent sampling time points according to multiple pieces of position information that are continuously reported by a shake detector, and wherein position information changing gets smaller when the time interval gets longer.
